(19) United States
(12) Patent Application Publication
(10) Pub. No.: US 2024/0392803 A1
(43) Pub. Date: Nov. 28, 2024

(54) ENGINE HAVING CENTRIFUGAL COMPRESSOR, ANNULAR COMBUSTION CHAMBER AND A GUIDE CHANNEL ARRANGEMENT HAVING DIFFERENT GUIDE CHANNEL ELEMENTS

(71) Applicant: ROLLS-ROYCE DEUTSCHLAND LTD & CO KG, Blankenfelde-Mahlow (DE)

(72) Inventor: Predrag TODOROVIC, Berlin (DE)

(21) Appl. No.: 18/685,122

(22) PCT Filed: Sep. 20, 2022
(86) PCT No.: PCT/EP2022/076061

§ 371 Date: Feb. 20, 2024

(30) Foreign Application Priority Data
Sep. 28, 2021 (DE) 10 2021 125 045.5

(51) Int. Cl. F04D 29/44; F04D 17/10; F23R 3/10

(52) U.S. Cl. CPC F04D 29/441; F04D 17/10; F23R 3/10

(57) ABSTRACT

The invention relates to an engine, having—a centrifugal compressor, —an annular combustion chamber, which is arranged downstream of the centrifugal compressor in a longitudinal direction along an engine axis, —a turbine, which is arranged downstream of the annular combustion chamber in the longitudinal direction, and—arranged between the centrifugal compressor and the annular combustion chamber a guide channel arrangement, which is designed to deflect air flowing out of the centrifugal compressor. The guide channel arrangement comprises at least two different types of guide channel elements, which are designed to deflect air flowing out of the centrifugal compressor at different angles of outflow toward the engine axis and thus to deflect, with differing degrees of intensity, air flowing out of the centrifugal compressor in a circumferential direction extending around the engine axis.

The proposed solution relates to an engine having a centrifugal compressor and an annular combustion chamber.

Engines having a centrifugal compressor and an annular combustion chamber, in which air from the centrifugal compressor is led outward in the radial direction and is then deflected substantially in the opposite direction to the annular combustion chamber are widely known from the prior art. As described in EP 2 737 252 B1, here the centrifugal compressor is typically provided as a single or as a last compressor stage. From the annular combustion chamber, combustion gases arising during combustion are led to a turbine in the axial direction (relative to an engine axis). Engines constructed in this way, in particular gas turbine engines, are distinguished by a comparatively compact design. Thus, corresponding engines can typically be constructed to be lighter and shorter in the axial direction.

In order to guide the air coming from the centrifugal compressor in the direction of the annular combustion chamber, between the centrifugal compressor and the annular combustion chamber a guide channel arrangement is provided which, in EP 2 737 522 B1, is also designated as a guide vane system or guide vane arrangement. This guide channel arrangement is used in particular to retard the flow, typically to a Mach number of less than 0.2, and for the flow deflection. While, here, conventional solutions typically provide a deflection of the airflow in such a way that the air flowing out of the guide channel arrangement only still has an axial directional component, EP 2 737 252 B1 provides for the air deflected by the guide channel arrangement to flow out at an outflow angle of, for example, 20° to quasi 90° relative to the engine axis. In this way, air from the guide channel arrangement flows with a swirl into an outer housing accommodating the combustion chamber. The guide channel arrangement of EP 2 737 252 B1 thus permits an airflow coming from the centrifugal compressor not to flow out along an exclusively axially aligned flow direction but at a predefined outflow angle (residual swirl angle) which, for example, lies between 20° and quasi 90°. In combination with injection nozzles additionally oriented along an at an angle to the engine axis, therefore a swirl flow that is advantageous with regard to the combustion and the dimensions of the engine, on the basis of the solution proposed in EP 2 737 252 B1, can also be produced within the combustion space of the combustion chamber.

Nevertheless, the solution proposed in EP 2 737 252 B1 still leaves room for additional improvements. This likewise applies to comparably constructed engines having a centrifugal compressor and an annular combustion chamber.

Against this background, the proposed solution provides an engine which—in addition to a centrifugal compressor (radial compressor) and an annular combustion chamber arranged downstream of the centrifugal compressor in a longitudinal direction along an engine axis—comprises a guide channel arrangement which is arranged between the centrifugal compressor and the annular combustion chamber and which comprises at least two different types of guide channel elements. These different types of guide channel elements are provided to deflect air flowing out of the centrifugal compressor with different outflow angles (swirl angles) relative to the engine axis and therefore to divert air flowing out of the centrifugal compressor to different extents into a circumferential direction pointing around the engine axis.

Depending on the type of guide channel element, a different extent and therefore a different level of deflection of air flowing out of the centrifugal compressor with respect to the engine axis is provided. For this purpose, the different types of guide channel elements differ, for example in their dimensions and/or geometries, in particular with regard to their air guide channels and outlet openings respectively defined by the guide channel elements. Here, regardless of the guide channel element, the deflected airflow is intended always to have a flow proportion and therefore a directional component in the circumferential direction about the engine axis. An airflow from a guide channel element of a guide channel arrangement according to the proposed solution therefore always has a swirl. Depending on the type of guide channel element, however, a different level of swirl is provided and, consequently, the respective airflow is deflected to a differently great extent in the circumferential direction.

The proposed solution is therefore based on the basic idea of generating a swirling flow via each of the at least two different types of guide channel elements and then, for example, of guiding it into an outer housing of the engine which has the annular combustion chamber. Here, however, in particular the flow direction is specifically set differently, depending on the type. In this way, for example, relatively large pressure differences of the supplied air in different zones in and around the annular combustion chamber can be avoided. In addition, a more uniform supply of air into a combustion space of the annular combustion chamber can be achieved via air mixing holes in the combustion chamber wall.

The guide channel arrangement is thus—for example in away analogous to the solution from EP 2 737 252 B1—also intended to retard the airflow originating from the centrifugal compressor (via guide channels of the guide channel arrangement each configured as a diffuser) and the supply of air into an outer housing accommodating an annular combustion chamber, so that, relative to the engine axis, the air then flows radially inwards firstly partly into a combustion space of the combustion chamber and secondly along front and rear combustion chamber walls of the annular combustion chamber, relative to the longitudinal direction. However, while previously known solutions with exactly one type of guide channel element under certain circumstances guide the airflow unevenly into the combustion space and along the combustion chamber with the aid of the outer housing, the proposed solution aims to achieve evening out of the airflow via different types of guide channel elements of the guide channel arrangement and to distribute the air coming out of the centrifugal compressor more specifically to different regions as early as when it leaves the guide channel arrangement. For this purpose, the different types of guide channel element are provided, each being designed for a different type of deflection, in particular for deflections of the air flowing out with different flow components in the circumferential direction.

For example, a first type of the at least two different types of guide channel elements for deflecting air flowing out of the centrifugal compressor is designed in such a way that, at at least one outlet opening of a guide channel element of the first type, an airflow along a first flow direction is generated which, relative to the engine axis, comprises both a first directional component in the circumferential direction and also a directional component in the longitudinal direction. A second type of the at least two different types of guide channel elements is further then designed to deflect air flowing out of the centrifugal compressor in such a way that, at at least one outlet opening of a guide channel element of the second type, an airflow along a second flow direction is generated, which comprises a second directional component in the circumferential direction which is greater than the first directional component of the first flow direction for a guide channel element of the first type. Thus, along the respective flow direction, for example, air in each case flows into an outer housing of the engine that accommodates the annular combustion chamber but here with differently pronounced directional components and therefore proportions in the circumferential direction. Thus, the second flow direction for air flowing out of the outlet opening of a guide channel element of the second type then has, for example, a greater proportion in the circumferential direction than the first flow direction. If necessary, the flow direction of the airflow from one guide channel element of the second type additionally has a smaller proportion in the longitudinal direction (axial direction). Depending on the flow direction, air from a guide channel element of the first or second type of the guide channel arrangement can (more) specifically be made to flow into different regions of a housing space surrounding the annular combustion chamber.

Relative to the longitudinal direction pointing along the engine axis, the annular combustion chamber typically has a front combustion chamber wall and a rear combustion chamber wall and also an end face connecting the front and rear combustion chamber walls. Via the end face, air passes along a radial inflow direction into the combustion space of the annular combustion chamber. In turn, additional mixing air for the combustion in the combustion space is guided via mixing air holes on the front and rear combustion chamber walls. Cooling openings can also be provided on the combustion chamber wall for the production of a cooling airflow.

Via the different types of guide channel elements, regions on and in the annular combustion chamber can more specifically be supplied with air from the guide channel arrangement. For example, a first type of the at least two different types of guide channel elements is designed to deflect air flowing out of the centrifugal compressor to the rear combustion chamber wall, while a second type of the at least two different types of guide channel elements is designed to deflect air flowing out of the centrifugal compressor to the front combustion chamber wall. Here, use can also be made of the aspect explained previously, in which, depending on the type of guide channel element, an airflow with a different flow direction is produced and in particular with a different proportion in the circumferential direction. In combination with a directional component which is in any case inherent in the airflow from the centrifugal compressor and points in the radial direction, an airflow from a guide channel element, for example with a proportionately stronger orientation in the circumferential direction, can be achieved, which is effectively deflected in the region of 180°. Therefore a deflection considerably more intense in the direction of a front combustion chamber wall can be achieved than is the case in previously usual constructions.

For example, a guide channel element of the first type is designed to deflect air flowing out of the centrifugal compressor in the direction of an intermediate space which is formed between the rear combustion chamber wall of the annular combustion chamber and a wall of an outer housing which accommodates the annular combustion chamber. Alternatively or additionally, a guide channel element of the second type can be designed to deflect air flowing out of the centrifugal compressor in the direction of a (different) intermediate space which is formed between a rear wall of the guide channel arrangement and the front combustion chamber wall of the annular combustion chamber. With the aid of the different types of guide channel elements, air is thus guided specifically in particular in the direction of the front and rear intermediate spaces and therefore along combustion chamber walls of the annular combustion chamber. In this way, a more uniform distribution of the air coming from the centrifugal compressor and, in particular, an improved flow of air into the combustion space via mixing air holes in the combustion chamber wall, can be achieved. Thus, for example, it has been shown that, with an appropriate configuration of a guide channel element of a second type for the deflection of air flowing out of the centrifugal compressor with a flow direction aligned proportionally more highly in the circumferential direction, an airflow deflected in the region of 180° can be achieved in an outer housing accommodating the annular combustion chamber, which is then also guided radially inward along a rear wall of the guide channel arrangement, and this is also still with comparatively low flow losses.

The guide channel elements can in principle each comprise at least one air guide channel, in particular an air guide channel widened in the manner of a diffuser for retarding the airflow. An air guide channel of a guide channel element of one type and an air guide channel of a guide channel element of a different type then have different lengths, for example, in one design variant and/or are curved to different extents in the circumferential direction. For example, this includes one air guide channel of a guide channel element of a first type being longer and curved less in the circumferential direction than an air guide channel of each other type of the at least two types of guide channel elements. An air guide channel of a guide channel element of a first type is thus designed to have a greater length as compared with an air guide channel of a guide channel element of another type but, for this purpose, with a smaller curve, i.e. a larger bending radius. A sharper curve in the circumferential direction with a smaller length in an air guide channel then results, for example, in an airflow generated thereby which has a more intense swirl and is aligned in the circumferential direction.

An air guide channel in each case has at least one outlet opening, wherein in one design variant, an outlet opening of an air guide channel of a guide channel element of one type is arranged radially further out relative to the engine axis than an outlet opening of an air guide channel of a guide channel element of a different type. By means of the radial offset of the outlet openings, it is not only possible to define different inflow regions better. Instead, via the radially offset outlet openings, the flow direction can also be predefined more variably, without the (partial) flows influencing one another too highly.

In one design variant, guide channel elements of different types are provided in a predefined sequence along the circumferential direction on the guide channel arrangement. For example, this includes a specific number of guide channel elements of one type being followed by a specific number of guide channel elements of another type. For example, each 2nd, 3rd or 4th guide channel element can be a different type.

In one design variant, with a view to effective evening out of the airflows into an outer housing surrounding the annular combustion chamber, provision is made for guide channel elements of a first type and guide channel elements of a second type to be provided alternately on the guide channel arrangement. Here, each second guide channel element in the circumferential direction is consequently designed differently. Here, the guide channel elements of different first and second types can, for example, be distributed uniformly on a circumference of the guide channel arrangement. For example, 10 to 15 of each type of guide channel element can be distributed uniformly over a circumference. In other words, for example, 10 to 15 guide channel elements of a first type and 10 to 15 guide channel elements of a second type are then distributed uniformly over the circumference of the guide channel arrangement.

In one design variant, the guide channel arrangement comprises at least three different types of guide channel elements. A third type of guide channel element here can be designed, for example, to deflect air flowing out of the centrifugal compressor in the direction of an end face of the annular combustion chamber. For example, a deflection in the circumferential direction can decrease from the first type via the third type to the second type of guide channel elements, so that an airflow from an outlet opening of a guide channel element of the first type is primarily aimed at a rear combustion chamber wall, an airflow from an outlet opening of an air guide channel element of the third type is primarily aimed at the end face of the annular combustion chamber, and an airflow from an outlet opening of a guide channel element of the second type is primarily aimed at a front combustion chamber wall.

In one design variant, the guide channel arrangement has two different first and second channel components. A guide channel element of the first type is provided on the first channel component, in particular formed thereon, while both a guide channel element of the second type and also a guide channel element of the third type are (jointly) provided, in particular formed, on the other, second channel component. While thus a first channel component—of possibly a plurality of first channel components—always integrates only exactly one guide channel element of the first type, a second channel component separate therefrom—of possibly a plurality of second channel components—integrates two different types of guide channel elements, namely both a guide channel element of the second type and also a guide channel element of the third type.

For example, in this connection provision is made for different guide channel sections for the different air guide channels of the guide channel elements of the second and third type to be provided at a radially outer end of the second channel component. The second channel component thus defines, for example, a common guide channel section for both guide channel elements of the second and third type. This common guide channel section is followed by an end piece, in which two different guide channel sections are defined, so that an airflow coming from the common guide channel section is distributed to two separate air guide channels for the guide channel elements of the second and third type. Within the second channel component, a distribution of the airflow coming from the common guide channel section to two partial flows is thus provided. Thus, it has transpired that via a single second channel component, for example, two shorter and more highly curved air guide channels for guide channel elements of a second and third type can be formed comparatively simply. Via the latter, two airflows are then generated which are aligned more highly in the direction of a front combustion chamber wall and the end face of the annular combustion chamber, while an airflow that has a less intense swirl is produced for a rear combustion chamber wall via an air guide channel having a first channel component that is longer and has a smaller curve.

In this connection, outlet openings spaced radially from one another (relative to the engine axis) for the two different guide channel elements can be formed on the second channel component. Thus, for example, an outlet opening for a guide channel element of the second type is then spaced apart radially from an outlet opening for a guide channel element of the third type.

In particular, this includes an outlet opening for one guide channel element of the second type (and here then, for example, for the production of an airflow to the front combustion chamber wall) being provided radially further in than an outlet opening of a guide channel element of the third type.

The proposed solution further also comprises an aircraft, in particular an airplane, having a design variant of a proposed engine.

The appended figures depict possible design variants of the proposed solution by way of example.

In the figures:

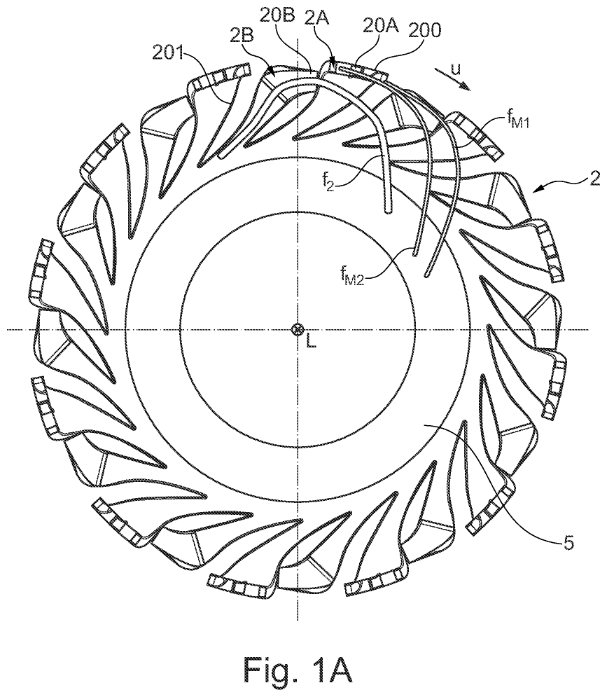

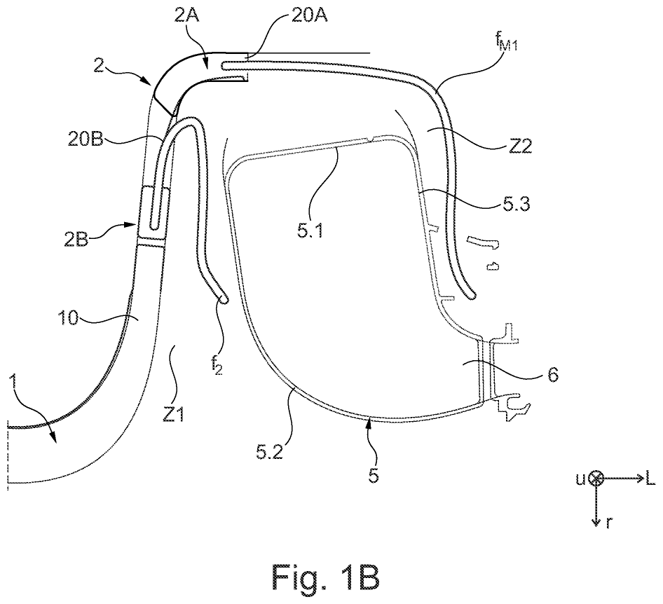

FIG. 1A shows, as a detail and with a view along an engine axis, a first design variant of the proposed solution with a guide channel arrangement having two alternating types of guide channel elements for deflecting an airflow originating from a centrifugal compressor to an annular combustion chamber;

FIG. 1B shows the design variant of FIG. 1A in a detail and in a sectional view with the example of a display of the airflows to be traced back to the different guide channel elements; and

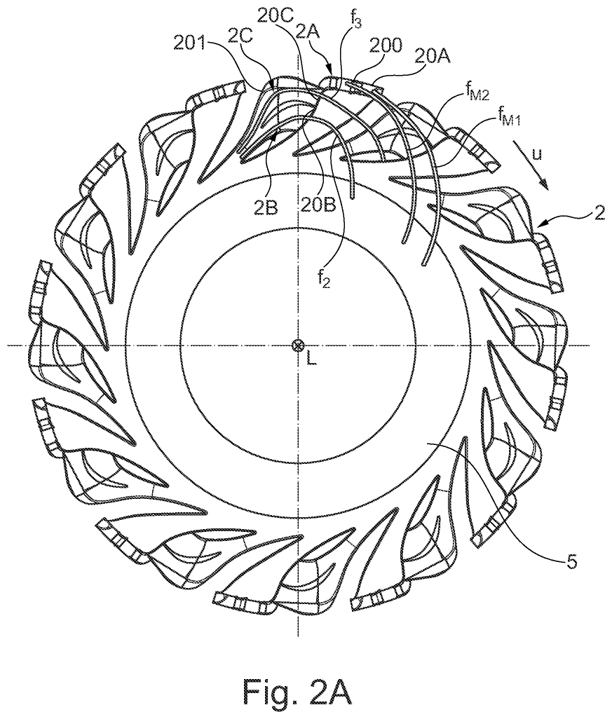

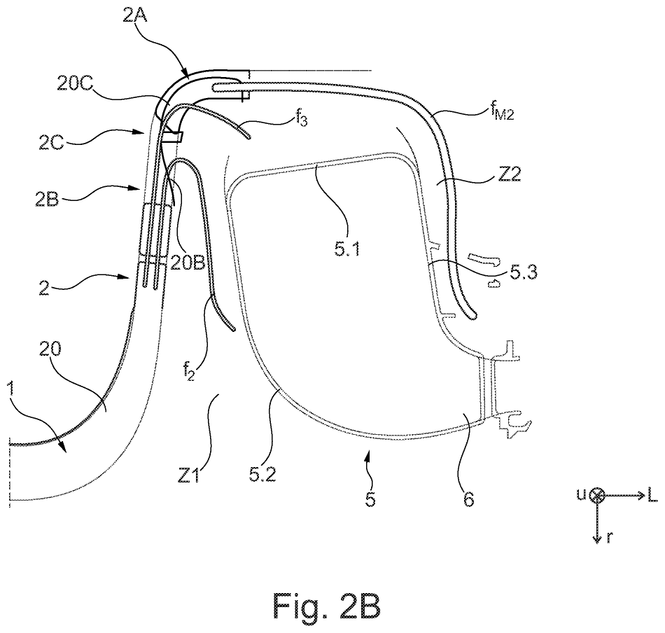

FIG. 2A shows, in a view corresponding to FIG. 1A, a further design variant having three different types of guide channel elements, of which two types of guide channel elements are provided on a common channel component;

FIG. 2B shows, in a view corresponding to FIG. 1A, the design variant of FIG. 2A;

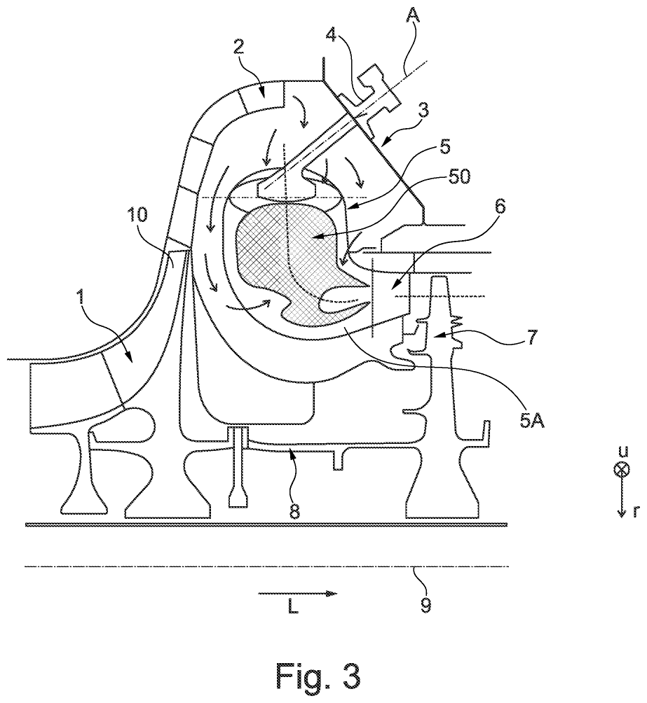

FIG. 3 shows a sectional view of a combustion chamber arrangement for the design variants illustrated in FIGS. 1A to 2B with a partial illustration of a centrifugal compressor provided upstream of the guide channel arrangement and a turbine provided downstream of the annular combustion chamber;

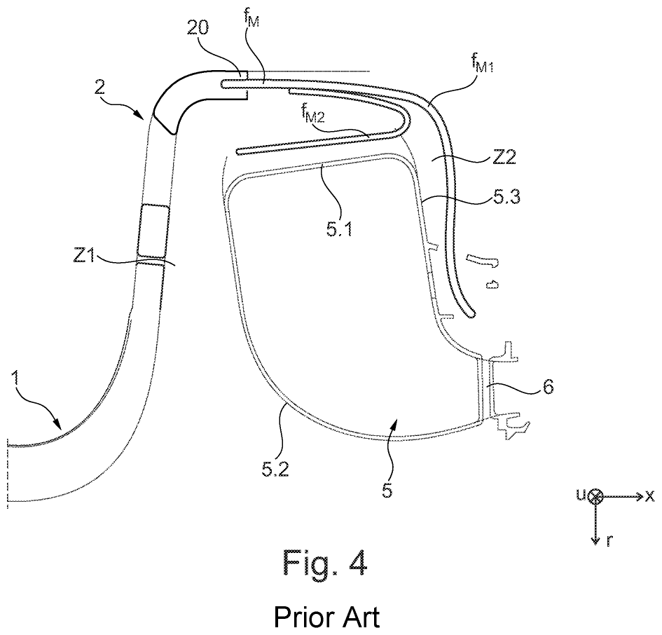

FIG. 4 shows, in a view corresponding to FIGS. 1B and 2B, a guide channel arrangement known from the prior art, illustrating the airflow that can be produced there with a single type of guide channel element.

FIG. 3 shows in a sectional view a part of an engine in which a centrifugal compressor 1 having a radial or centrifugal compressor impeller 10 is provided as a last or single compressor stage. Air compressed by the centrifugal compressor 1 passes via a guide channel arrangement 2 into an outer housing 3, in which an annular combustion chamber 5 is accommodated. The annular combustion chamber 5 is arranged after the centrifugal compressor 1 in a longitudinal direction L along an engine axis 9. The centrifugal compressor impeller 10 rotates about this engine axis 9.

The air emerging from the centrifugal compressor 1 is deflected and retarded via the guide channel arrangement 2, so that the air enters a housing space of the outer housing 3 with a flow direction which has a directional component in the axial direction and therefore in the longitudinal direction L. Via an inner wall of the outer housing 3, the flow is led radially inward to the annular combustion chamber 5. As a result, air passes into a combustion space 5A of the annular combustion chamber 5, in which injection nozzles 4 are distributed over a circumference of the annular combustion chamber 5. These injection nozzles 4 are consequently arranged beside one another on the annular combustion chamber 5 along a circumferential direction u.

With the aid of the injection nozzles 4, a respective flame 50 can be produced, so that via the combustion taking place in the combustion space 5A and the combustion gases produced thereby, a high-pressure turbine 3 can be driven around the engine axis 9 to produce thrust. The combustion gases are led out of the combustion space 5A via turbine guide vanes 6 in the longitudinal direction L to the high-pressure turbine 7. A turbine shaft 8 is provided for the rotatable mounting of the high-pressure turbine 7 about the engine axis 9.

The air originating from the guide channel arrangement 5 is firstly led inward into the combustion space 5A on an end face of the combustion chamber 5 along a radial direction r. Furthermore, mixing air holes are provided in a manner known per se on front and rear combustion chamber walls of the combustion chamber 5, in order to allow additional mixing air to flow into the combustion space 5A.

In a way corresponding to the solution known from EP 2 737 252 B1, air flowing out of the centrifugal compressor 1 can be deflected via the guide channel arrangement 2 in such a way that, corresponding to the enlarged sectional view of FIG. 4, at an outlet opening 20 of the guide channel arrangement, a respective airflow into the outer housing 3 is produced, which is proportionally aligned both in the circumferential direction u and also in the axial direction and therefore in the longitudinal direction L. The air is thus caused to flow into the outer housing 3 with a predefined swirl, which may be advantageous for the flow management and combustion, in particular combined with injection nozzles 4 possibly aligned at a specific angle relative to the engine axis 9. For this purpose, mid-axes A of an injection nozzle 4 can be inclined at a specific angle of, for example, 30° to 40°, to a meridian plane extending through the engine axis 9.

Irrespective of the orientation of the injection nozzles 4, an airflow fM flowing out of each outlet opening 20 of the guide channel arrangement 2 has an outflow angle of greater than 0° and is therefore not just aligned in the longitudinal direction L. Via the configuration of the outer housing 3 and the (residual) swirl set specifically or maintained in the airflow fM, the result in the housing space of the outer housing 3 and in particular around the annular combustion chamber 5 is at least two primary (partial) airflows f_{M1} and f_{M2}. Here, one airflow f_{M1} primarily transports air into an intermediate space Z2 which, corresponding to the sectional view of FIG. 4, is present between a rear combustion chamber wall 5.3 of the annular combustion chamber 5 and an inner wall of the outer housing 3. Via the other airflow f_{M2}, in turn at least part of the air originating from the centrifugal compressor is transported into an intermediate space Z1, which is defined between a front combustion chamber wall 5.2 and a rear wall of the guide channel arrangement 2. This airflow f_{M2} results from a primarily axial deflection, caused by the housing, in the region of 180°, so that with the airflow f_{M2}, air is firstly guided over an end face 5.1 of the annular combustion chamber 5 connecting the front and rear combustion chamber walls 5.2, 5.3 to each other, before it reaches the front intermediate space Z1. In addition, combustion air is intended to get into the combustion space 5A via the end face 5.1. At the same time, additional mixing air is intended to flow into the combustion space 5A both via mixing air holes in the front combustion chamber wall 5.2 and via mixing air holes in the rear combustion chamber wall 5.3. With the solution known from the prior art having a guide channel arrangement 2 corresponding to FIG. 4 with exactly one type of guide channel element 2 for the retardation and deflection of the air flowing out of the centrifugal compressor 1, the result under certain circumstances is a comparatively non-uniform distribution of the air around the annular combustion chamber 5.

Here, the proposed solution creates a remedy, in relation to which the possible design variants are illustrated with reference to FIGS. 1A-1B and 2A-2B.

In the design variant of FIGS. 1A and 1B, different types of guide channel elements 2A and 2B, which deflect an airflow coming from the centrifugal compressor 1 to different extents in the circumferential direction u, are provided alternately along the circumferential direction u on the guide channel arrangement 2. FIG. 1A shows the guide channel arrangement 2 with a view along the engine axis 9, while FIG. 1B shows a sectional view.

In the guide channel arrangement 2 of FIGS. 1A and 1B, a first guide channel element 2A and therefore a guide channel element of a first type for the primary airflow fM is configured in an analogous way to a guide channel arrangement 2 according to FIG. 4 known from the prior art. Via one or more outlet openings 20A of such a guide channel element 2A, the airflow fM, which comprises directional components both in the circumferential direction u and in the longitudinal direction L, therefore emerges along the flow direction. For this purpose, for example guide vanes or outlet guide wheels are provided on the guide channel element 2A widening in the manner of a diffuser and extending radially outward and, respectively, in an air guide channel defined thereby.

As distinct from the solution known from the prior art, in the design variant of FIGS. 1A and 1B, however, each second guide channel element 2B is now configured differently. An outlet opening 20B of this guide channel element 2B of a second type is firstly located radially further in than an outlet opening 20A of a guide channel element 2A of the first type. Furthermore, an air guide channel defined herein and widening in the manner of a diffuser is designed to be shorter and curved more sharply in the circumferential direction u. A (secondary) airflow f₂ produced by this channel guide element 2B of the second type thus has a proportionally greater flow component along the circumferential direction u. In combination with a radial flow component already inherent in the flow from the centrifugal compressor 1, this leads to a deflection of the air flowing out at the outlet opening 20B of the second guide channel element 2B in the region of 180° (cf. sectional view of FIG. 1B).

It has been shown that, as a result of forming an air guide channel that is shorter and curved more highly in the direction of the circumferential direction u in a guide channel element 2B of a second type, a deflection of the air flowing out of the centrifugal compressor 1 in the region of 180° can be achieved and, here, the retarded, deflected airflow then flows substantially radially inward and primarily along the front combustion chamber wall 5.3. An airflow f_{M} with the (partial) airflows f_{M1} and f_{M2} resulting from this out of a guide channel element 2A of a first type is thus directed more intensely in the direction of the second, rear intermediate space Z2, which is present between the rear combustion chamber wall 5.3 and an inner wall of the outer housing 3, than an airflow f₂ from an outlet opening 20B of a guide channel element 2B of the second type.

The airflow f₂ from an outlet opening 20B of a guide channel element 2B of the second type is primarily directed in the direction of the first, front intermediate space Z1 between a rear wall of the guide channel arrangement 2 and the front combustion chamber wall 5.2. As a result of the alternating arrangement of the different guide channel elements 2A and 2B, a more uniform distribution of the air coming from the centrifugal compressor 1 is thus achieved, in particular over the front and rear combustion chamber walls 5.2 and 5.3 of the annular combustion chamber 5.

In the development of FIGS. 2A and 2B, a third type of guide channel element 2C is additionally provided in the guide channel arrangement 2. This third type of guide channel element 2C in the present case is formed on one and the same channel component 201 of the guide channel arrangement 2 as a guide channel element 2B of the second type. While, therefore, in the design variant of FIGS. 1A and 1B, alternating channel components 200 and 201 for exactly one type of guide channel element 2A or 2B are provided along the circumferential direction u, in the design variant of FIGS. 2A and 2B, channel components 200 and 201 alternate along the circumferential direction u, of which a (first) channel component 200 is respectively provided for a guide channel element 2A of the first type and a differently configured (second) channel component 201 is respectively provided both for a guide channel element 2B of the second type and a guide channel element 2C of the third type.

On the (second) channel component 201 for the guide channel elements 2B, 2C of the second and third type, in each case a common guide channel section is provided which, on a radially outer end piece of each channel component 201, distributes an airflow coming from the centrifugal compressor 1 to two different air guide channels. Each of these air guide channels is part of one or the other guide channel element 2B or 2C. While one air guide channel for a guide channel element 2B of the second type ends at an outlet opening 20B of the channel component 201, the other air guide channel of the other guide channel element 2C of the third type ends at a different outlet opening 20C, which is offset radially relative to the outlet opening 20B of the guide channel element 2B of the second type. In the present case, for example, the outlet opening 20B for a guide channel element 2B of the second type is then located further in in the radial direction r than an outlet opening 20C of a guide channel element 2C of the third type. One or more outlet openings 20A of a guide channel element 2A of the first type are in turn respectively located radially furthest out.

As illustrated in more detail in particular with reference to the sectional view of FIG. 2B, a more intense distribution and alignment of the airflows produced by the guide channel arrangement 2 is achieved via the guide channel elements 2A, 2B and 2C of the three different types. Thus, although an air guide channel of a guide channel element 2C of the third type continues to be formed shorter than an air guide channel of a guide element 2A of the first type, the air guide channel of a guide channel element 2C of the third type is curved less highly in the circumferential direction u than an air guide channel of a guide channel element 2B of the second type. Via a guide channel element 2C of the third type, in this way a fluid flow f₃ (likewise having a swirl) into the housing space of the outer housing 3 is produced but is aligned more highly in the direction of the radially outer end face 5.1 of the annular combustion chamber 5.

Via the different guide channel elements 2A, 2B or 2A, 2B, 2C arranged alternately on the circumference of a guide channel 2, air flowing out of the centrifugal compressor 1 can firstly not only be retarded but also deflected in a more targeted manner, as a result of which a more uniform distribution of the air in and in particular around the annular combustion chamber 5 can be achieved. This then also permits better control and influencing of the airflows with regard to the different reaction zones within the combustion space 5A of the annular combustion chamber 5.

### LIST OF DESIGNATIONS

1 Centrifugal compressor
10 Centrifugal compressor impeller
2 Guide channel arrangement
2A, 2B, 2C Guide channel element
20 Outlet opening
20A, 20B, 20C Outlet opening
200, 201 Channel component
3 Outer housing
4 Injection nozzle
5 Annular combustion chamber
5.1 End face
5.2 Front combustion chamber wall
5.3 Rear combustion chamber wall
50 Flame
5A Combustion space
6 Turbine guide vane
7 High-pressure turbine
8 Turbine shaft
9 Engine axis
A Mid-axis of the injection nozzle
f2, f3 (Secondary) airflow
f_{M}, f_{M1}, f_{M2} (Primary) airflow
L Longitudinal direction
r Radial direction
u Circumferential direction
Z1, Z2 Intermediate space

1. An engine having
a centrifugal compressor,
an annular combustion chamber, which is arranged after the centrifugal compressor in a longitudinal direction along an engine axis,
a turbine arranged after the annular combustion chamber in the longitudinal direction, and
a guide channel arrangement which is arranged between the centrifugal compressor and the annular combustion chamber and which is designed to deflect air flowing out of the centrifugal compressor,
wherein
the guide channel arrangement comprises at least two different types of guide channel elements, which are designed to deflect air flowing out of the centrifugal compressor with different outflow angles relative to the engine axis and therefore to divert air flowing out of the centrifugal compressor to different extents into a circumferential direction pointing around the engine axis.

2. The engine as claimed in claim 1, wherein
a first type of the at least two different types of guide channel elements for deflecting air flowing out of the centrifugal compressor is designed in such a way that, at least one outlet opening of a guide channel element of the first type, an airflow along a first flow direction is generated which, relative to the engine axis, comprises both a first directional component in the circumferential direction and also a directional component in the longitudinal direction, and
a second type of the at least two different types of guide channel elements is designed to deflect air flowing out of the centrifugal compressor in such a way that, at least one outlet opening of a guide channel element of the second type, an airflow along a second flow direction is generated, which comprises a second directional component in the circumferential direction which is greater than the first directional component of the first flow direction for a guide channel element of the first type.

3. The engine as claimed in claim 1, wherein relative to the longitudinal direction, the annular combustion chamber has a front combustion chamber wall and a rear combustion chamber wall and also an end face connecting the front and rear combustion chamber walls, which is provided for the inflow of air along a radial inflow direction relative to the engine axis into a combustion space of the annular combustion chamber, and in that
a first type of the at least two different types of guide channel elements is designed to deflect air flowing out of the centrifugal compressor to the rear combustion chamber wall, and
a second type of the at least two different types of guide channel elements is designed to deflect air flowing out of the centrifugal compressor to the front combustion chamber wall.

4. The engine as claimed in claim 3, wherein the engine comprises an outer housing accommodating the annular combustion chamber, and a guide channel element of the first type is designed to deflect air flowing out of the centrifugal compressor in the direction of an intermediate space formed between the rear combustion chamber wall and a wall of the outer housing.

5. The engine as claimed in claim 3, wherein a guide channel element of the second type is designed to deflect air flowing out of the centrifugal compressor in the direction of an intermediate space formed between a rear wall of the guide channel arrangement and the front combustion chamber wall.

6. The engine as claimed in claim 1, wherein the guide channel elements each comprise at least one air guide channel, wherein an air guide channel of a guide channel element of one type and an air guide channel of a guide channel element of a different type have different lengths and/or are curved to different extents in the circumferential direction.

7. The engine as claimed in claim 6, wherein an air guide channel of a guide channel element of a first type is longer and curved less in the circumferential direction than an air guide channel of each other type of guide channel element of the at least two types of guide channel elements.

8. The engine as claimed in claim 6, wherein an air guide channel in each case has at least one outlet opening, and an outlet opening of an air guide channel of a guide channel element of one type is arranged radially further out relative to the engine axis than an outlet opening of an air guide channel of a guide channel element of a different type.

9. The engine as claimed in claim 1, wherein guide channel elements of different types are arranged in a predefined sequence along the circumferential direction.

10. The engine as claimed in claim 9, wherein guide channel elements of a first type and guide channel elements of a second type are provided alternately on the guide channel arrangement.

11. The engine as claimed in claim 1, wherein the guide channel arrangement comprises at least three different types of guide channel elements.

12. The engine as claimed in claim 3, wherein a guide channel element of a third type is designed to deflect air flowing out of the centrifugal compressor in the direction of the end face of the annular combustion chamber.

13. The engine as claimed in claim 11, wherein a guide channel element of the first type is provided on a first channel component of the guide channel arrangement, and both a guide channel element of the second type and a guide channel element of the third type are provided on another, second channel component.

14. The engine as claimed in claim 13, wherein outlet openings spaced radially from one another relative to the engine axis for the two different guide channel elements are formed on the second channel component.

15. An aircraft having an engine according to claim 1.
